(19) United States
(12) Patent Application Publication
(10) Pub. No.: US 2012/0218385 A1
(43) Pub. Date: Aug. 30, 2012

(54) VIDEO SIGNAL PROCESSING DEVICE

(75) Inventors: Nobutoshi FUJINAMI, Osaka (JP); Noriyuki Iwakura, Hokkaido (JP); Natsumi Yano, Hokkaido (JP)

(73) Assignee: Panasonic Corporation, Osaka (JP)

(21) Appl. No.: 13/400,975

(22) Filed: Feb. 21, 2012

(30) Foreign Application Priority Data
Feb. 28, 2011 (JP) JP 2011-041355

(51) Int. Cl. H04N 13/00

(52) U.S. Cl. 348/43; 348/E13.002

(57) ABSTRACT

A video signal processing device includes a subfield conversion unit which converts a frame signal, which is a video signal corresponding to one frame of video, into a plurality of subfields corresponding to the frame signal, a drive parameter setting unit which sets a luminance weight and a light emitting position in the plurality of subfields for each of the plurality of subfields, a calculation unit which calculates a filtering-in amount of the frame signal corresponding to the plurality of subfields based on a signal level of the frame signal, the setup luminance weight, and the light emitting position, and a subtraction unit which subtracts the filtering-in amount from a signal level of a frame signal input to the subfield conversion unit subsequent to the frame signal.

### FIELD OF THE INVENTION

The present invention relates to a video display device. More specifically, the present invention relates to a video display device that can display a three-dimensional video by utilizing a time-sharing display approach and prevent an image quality from deteriorating due to the occurrence of a crosstalk.

### BACKGROUND OF THE INVENTION

In recent years, a video display device has been developed proactively which would display a three-dimensional video by using a plasma display panel (hereinafter abbreviated as a “PDP”). To display a three-dimensional video by the video display device, the time-sharing display approach is typically used. By the time-sharing display approach, different videos are alternately displayed to the user of the video display device so that he may perceive a three-dimensional video. The video to be displayed includes a right-eye video and a left-eye video which have a difference in parallax from each other. The user wears shutter-attached glasses to appreciate the video which is displayed. The shutter-attached glasses include a shutter which blocks the viewfield of his right eye and that which blocks the viewfield of his left eye. When the right-eye video is displayed, the left-eye side shutter is closed so that the relevant video may be seen by his right eye, and when the left-eye video is displayed, the right-eye side shutter is closed so that the relevant video may be seen by his left eye.

The following will specifically describe processing in which the video display device displays a three-dimensional video. The video display device opens/closes the LCD filter shutters respectively disposed to a right-eye lens and a left-eye lens in synchronization with the timing at which the right-eye video and the left-eye video to be displayed on a display panel are switched from each other. That is, in synchronization with the timing at which the right-eye image is switched on, the LCD filter shutter disposed to the right-eye lens is opened to let the light pass through and the LCD filter shutter disposed to the left-eye lens is closed to block the light, thereby permitting the right-eye video to be seen only by the right eye. In synchronization with the timing at which the left-eye image is switched on, the LCD filter shutter disposed to the left-eye lens is opened to let the light pass through and the LCD filter shutter disposed to the right-eye lens is closed to block the light, thereby permitting the left-eye video to be seen only by the left eye. The timing at which the right-eye video and the left-eye video are switched on/off and the timing at which the LCD filter shutters are opened/closed are synchronized with each other by connecting the display panel and the pair of glasses wirelessly by or wiredly. By repeating it continually, the viewer can see a three-dimensional video based on the right-eye video and the left-eye video.

One of the problems of the video display device for displaying videos is a crosstalk. A crosstalk occurs if the right-eye video or the left-eye video is perceived visually on the left eye or the right eye respectively. If a crosstalk occurs, the user cannot correctly appreciate the three-dimensional video.

A crosstalk occurs mainly owing to an afterglow of the video. More precisely, it occurs due to an afterglow produced by picture elements of the PDP. A video appears on the PDP when a video signal is applied to the PDP. On the PDP, a phosphor formed of a lot of picture elements is disposed. When the phosphor emits light in continual patterns, the PDP expresses a video. However, the surface of the phosphor has properties that light stays behind slightly. Therefore, even after the video signal is switched off, the PDP still displays the previous video even for a short lapse of time. That is, by the time-sharing display approach, the left-eye video filters in the right-eye video. Further, the right-eye video may possibly filter in the left-eye video. A video generated by the filtering in is referred to as a crosstalk.

To solve the problem of such a crosstalk, various solutions have been worked out. The typical one is a method described in, for example, Unexamined Japanese Patent Publication No. 2001-54142, by which a crosstalk due to the previous video is subtracted from the subsequent video. An input video is multiplied by coefficient α to calculate a crosstalk and the crosstalk is subtracted from the subsequent video. If the value of coefficient α can be defined precisely, the crosstalk can be prevented logically.

However, even this conventional technology cannot solve the problem of the crosstalk. That is, in Unexamined Japanese Patent Publication No. 2001-54142, coefficient α to calculate a crosstalk is assumed to be calculated inductively from a video signal beforehand. It is considered that if coefficient α corresponding to the video signal is predetermined, the crosstalk can be prevented logically.

However, on the PDP, a crosstalk is not simply determined uniquely from the video signal. That is, the PDP employs a drive method by use of subfields, so that the same video may possibly be expressed with the different video signals A and B. Therefore, a crosstalk of a video expressed with the video signal A may possibly be different from that of a video expressed with the video signal B.

A reason why the same video has different crosstalks will be described in detail as follows. The PDP performs operations to superimpose a plurality of different videos (subfields) which are switched on momentarily. This display method is referred to as the subfield method. The user would perceive the combined subfield as one sheet of video.

The drive method by use of subfields will be outlined as follows. The purpose of using the drive method by use of subfields is to express the gradation of a video by displaying a plurality of subfields in different period. Typically, four to 14 subfields are used for one sheet of video. Each sheet of the subfield has a different display period. A method for setting the period will be described as follows. The PDP displays an image only momentarily each time it discharges. The number of times the discharge is performed during the subfield may be said to give the period of time to display the subfield. The number of times of performing discharge (=number of times of emitting light) is referred to as the weight of the subfield. For example, assuming that the eight sheets of subfield are displayed sequentially and their weights are set in order of 1, 2, 4, 8, 16, 32, 64, and 128. Such setting enables expressing 256 levels of gradation. For example, to display a video having a brightness of 10, the second and fourth subfield can be displayed.

Taking into account the characteristics of the subfield method, the technology described in Unexamined Japanese Patent Publication No. 2001-54142 described above cannot be applied as it is. Because they have the different order of subfield weighting and the different filtering-in amounts for the subfields to be displayed. As described above, an afterglow occurs on a video. The subfield is one kind of video. Therefore, precisely, the PDP involves generation of afterglows having the different characteristics of the different sheets of subfields not of the video signal. That is, for example, it is understood that the order in which the subfields are weighted has a large influence on a crosstalk.

That is, the conventional technologies have not completely been able to prevent the crosstalk on the PDP. Therefore, there has been a problem in that the user cannot correctly appreciate the three-dimensional video.

### SUMMARY OF THE INVENTION

A video signal processing device of the present invention includes a subfield conversion unit, a drive parameter setting unit, a calculation unit, and a subtraction unit. The subfield conversion unit converts a frame signal, which is a video signal corresponding to one frame of video, into a plurality of subfields corresponding to the frame signal. The drive parameter setting unit sets a luminance weight and a light emitting position in the plurality of subfields for each of the plurality of subfields. The calculation unit calculates the filtering-in amount of the frame signal corresponding to the plurality of subfields based on a signal level of the frame signal as well as the setup luminance weight and light emitting position. The subtraction unit subtracts the filtering-in amount from a signal level of a frame signal input to the subfield conversion unit subsequent to the frame signal.

By such a configuration, the filtering-in amounts for the subfields are summed and subtracted from the subsequent frame, so that the filtering-in amount can be reduced accurately. As a result, it is possible to prevent a crosstalk from occurring between the frames.

### BRIEF DESCRIPTION OF DRAWINGS

FIG. 1 shows a functional block diagram of a video signal processing device according to an exemplary embodiment.

FIG. 2 shows a schematic diagram of a concept of a subfield signal according to the exemplary embodiment.

FIG. 3 shows an explanatory conceptual diagram of coefficient α according to the exemplary embodiment.

FIG. 4 shows an explanatory conceptual diagram of an operation state of the video signal processing device according to the exemplary embodiment.

FIG. 5 shows a conceptual diagram of the operation state of the video signal processing device according to the exemplary embodiment.

FIG. 6 shows a functional block diagram of the video signal processing device in another example according to the exemplary embodiment.

### DETAILED DESCRIPTION OF THE PREFERRED EMBODIMENT EXEMPLARY EMBODIMENT

The following will describe one exemplary embodiment of the present invention with reference to the drawings.

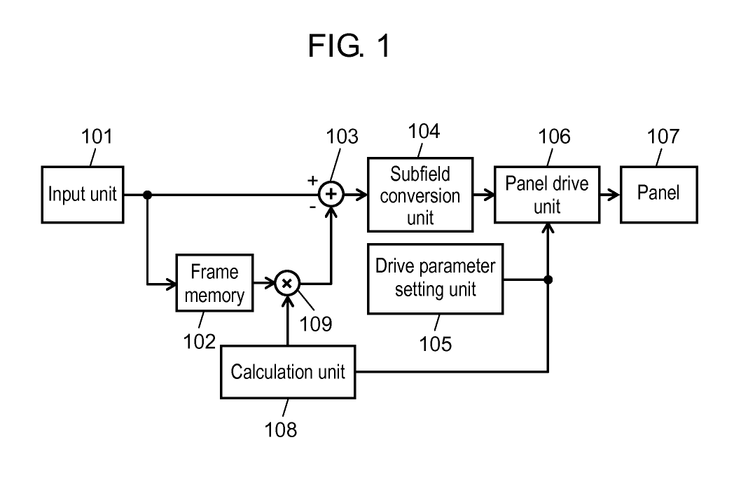

First, a description will be given of a configuration of a video signal processing device of the present exemplary embodiment with reference to FIG. 1. FIG. 1 shows a functional block diagram of the video signal processing device according to the exemplary embodiment. The video signal processing device has input unit 101, frame memory 102, combination unit 109, addition unit 103, subfield conversion unit 104, drive parameter setting unit 105, panel drive unit 106, and plasma display panel (hereinafter abbreviated as “panel”) 107. The following will describe the components shown in the functional block diagram.

Input unit 101 is supplied with a video signal. The video signal is formed of various components. The video signal may be, for example, a signal obtained by decoding a broadcast signal or may be a signal sent from a hard disk drive or media player connected inside or outside. The video signal is any one of the three primary color signals and the other two primary color signals may undergo almost the same signal processing. The video signal supplied to input unit 101 is transferred to frame memory 102 and addition unit 103.

Frame memory 102 extracts and accumulates one frame worth of video signal (hereinafter abbreviated as “frame signal”). Frame memory 102 extracts the frame signal from the video signal transferred from input unit 101. The frame signal is accumulated in frame memory 102 until the subsequent frame is written. The accumulated frame signal is transferred to combination unit 109 at the timing when the subsequent frame signal is written. That is, the video signal undergoes delay processing as much as one frame worth in frame memory 102.

Addition unit 103 subtracts a filtering-in amount from the video signal to produce a second video signal. The filtering-in amount refers to a signal level of afterglow that contributes to a crosstalk. Specifically, the filtering-in amount is calculated by spuriously converting a component of afterglow generated in the previous frame that is mixed into a video to be displayed in the subsequent frame into a video signal level. The second video signal is transferred to subfield conversion unit 104. The filtering-in amount calculation method will be described in detail later.

Subfield conversion unit 104 converts the second video signal into a subfield signal for each frame.

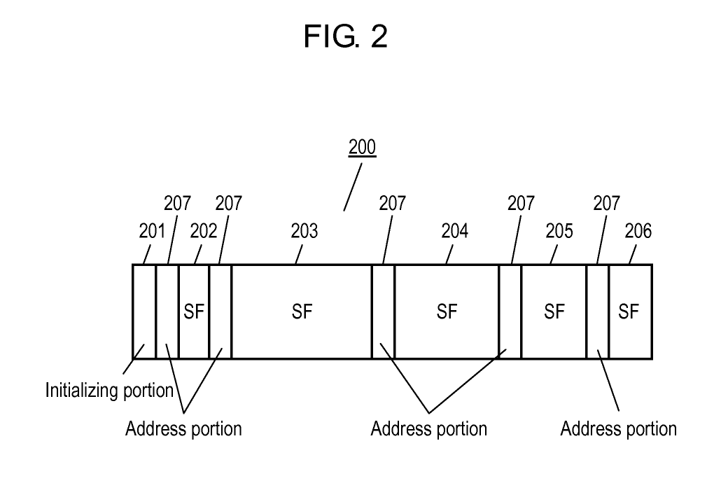

A description will be given of subfield signal 200 with reference to FIG. 2. FIG. 2 shows a schematic diagram of the concept of subfield signal 200 according to the exemplary embodiment. Subfield signal 200 has initialization portion 201, a plurality of subfields (described as “SF” in FIG. 2) from subfields 202 to 206, and a plurality of address portions 207. Address portion 207 is inserted between initialization portion 201 and subfield 202 and between subfields 202 and 206. Subfield signal 200 is used to display one frame worth of video in the second video signal. Initialization portion 201 is a signal configured to reset charge accumulated on panel 107. Subfields 202 to 206 are each a signal including a plurality of pulses to make panel 107 emit light. Subfields 202 to 206 typically include the different numbers of pulses. Address portion 207 is a signal configured to set a picture element where panel 107 is made emit light by the subfields subsequent to address portion 207 (subfields 202 to 206).

Subfield conversion unit 104 determines which subfield is to make panel 107 emit light. For example, it determines that subfields 203 and 204 are to make the panel emit light for frames of the input second video signal (subfields 202, 205, and 206 are not lit up). That is, the fact that subfield conversion unit 104 converts the second video signal into the subfield signal for each frame involves the generation of information to the effect that which subfield is to make panel 107 emit light and which subfield is not to make it emit light in the relevant frame. Generally, the more brightly a frame displays a video, the more subfields it has to make panel 107 emit light. The number of times a specific one of the subfields is to make panel 107 emit light (how many pulses are included in each subfield) is set by drive parameter setting unit 105 described below. Subfield signal 200 is transferred to panel drive unit 106. As described above, subfield conversion unit 104 converts the frame signal, which is a video signal corresponding to one frame of video, into a plurality of subfields corresponding to the frame signal.

Drive parameter setting unit 105 generates a drive parameter. The drive parameter is information that relates to weights and light emitting positions of subfields 202 to 206. The weight of the subfield is a setting of the number of times a specific subfield is to make panel 107 emit light. That is, it is the setting of how many pulses to make panel 107 emit light are included in each subfield. Further, the light emitting position of the subfield denotes the timing at which the subfield makes panel 107 emit light in a one frame of period of time. The weight and the light emitting position are determined by a setup state in which the video signal processing device is set. This setup state can be set also by the user of the video signal processing device. For example, an adjustment of the image quality of a video which is displayed on panel 107 has an influence on the parameters of the weight and the light emitting position. The drive parameter is input to panel drive unit 106 and calculation unit 108. As described above, drive parameter setting unit 105 sets a luminance weight and a light emitting position in a plurality of subfield for the individual one of the plurality of subfields.

Further, drive parameter setting unit 105 includes a circuit for controlling the shutter-attached glasses and a circuit for transmitting a control signal of the glasses. Those circuits switches the timing at which the shutter of the LCD filter disposed to each of a right-eye lens and a left-eye lens is opened/closed in synchronization with the timing at which a right-eye video and a left-eye video to be displayed on the display panel are switched from each other. That is, it opens the LCD filter shutter on the right-eye lens in synchronization with the timing at which the right-eye video is switched on so that the light may pass through and then closes the LCD filter shutter on the left-eye lens so that the light may be blocked, thereby permitting only the right eye to see the right-eye video. It opens the LCD filter shutter on the left-eye lens in synchronization with the timing at which the left-eye video is switched on so that the light may pass through and then closes the LCD filter shutter on the right-eye lens so that the light may be blocked, thereby permitting only the left eye to see the right-eye video.

Panel drive unit 106 generates a signal which drives panel 107 based on the subfield signal and the drive parameter. The subfield signal transferred from subfield conversion unit 104 includes information to the effect that which subfield is to make panel 107 emit light. The drive parameter transferred from drive parameter setting unit 105 includes information about the weight and the light emitting position of the subfield.

The following will describe one example where panel drive unit 106 generates a signal which drives panel 107. For example, it is assumed that the subfield signal includes the information to the effect that subfields 203 and 204 are to make panel 107 emit light. It is assumed that the drive parameter includes the information to the effect that subfields 202, 203, 204, 205, and 206 are to make panel 107 emit light 8 times, 128 times, 64 times, 32 times and 16 times respectively and the information about the light emitting order and timing of subfields 202 to 206. Then, panel drive unit 106 controls panel 107 so that it may emit light 128 times at the light emitting timing of subfield 203 and 64 times at the light emitting timing of subfield 204.

Panel 107 emits light under the control of panel drive unit 106. The scope in which the present invention is applied is not limited to a plasma display panel but broadly covers displays which are driven by the drive method by use of subfields.

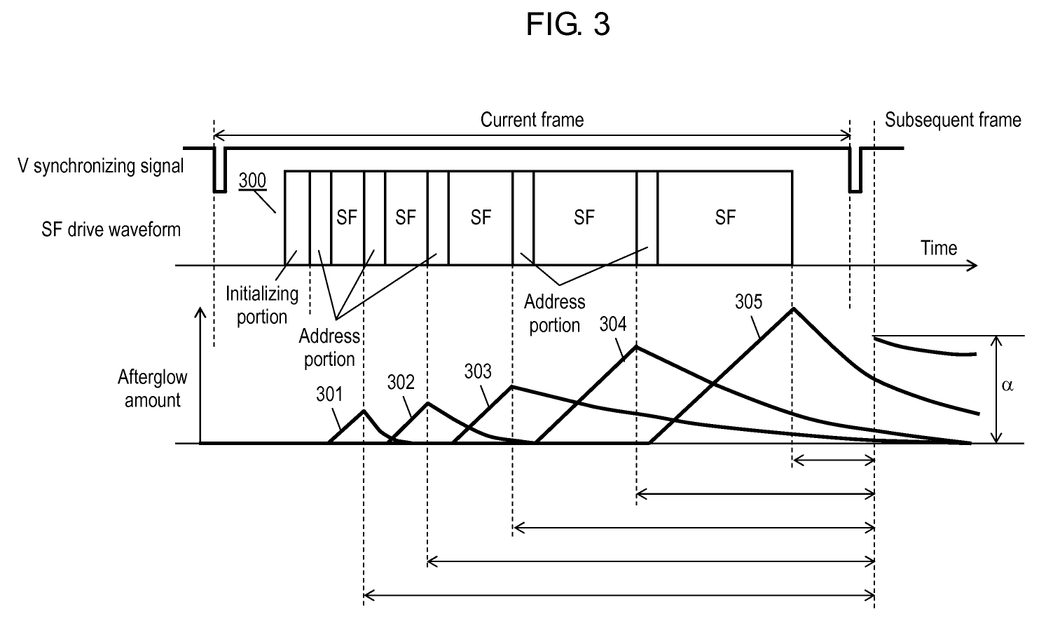

Calculation unit 108 is configured to set the value of coefficient α in accordance with the drive parameter. The value of coefficient α is set on the basis of a luminance weight and a light emitting position. The value of coefficient α will be described in detail with reference to FIG. 3.

FIG. 3 shows an explanatory conceptual diagram of coefficient α according to the exemplary embodiment. In FIG. 3, the top stage denotes a vertical synchronizing signal (V synchronizing signal). Below it, subfield signal 300 showing a subfield (SF) drive waveform is denoted. In FIG. 3, a horizontal axis gives time. The weights of subfield signal 300 are, for example, 8, 16, 32, 64, and 128 sequentially from the left. In this case, it is assumed that all of the subfields of subfield signal 300 make panel 107 emit light. The light emitting positions of subfield signal 300 are denoted by arrows at the bottom stage in FIG. 3. For simplification of the figure, one end of the arrow (leftmost end in FIG. 3) at the bottom stage denotes the end point in time of each subfield period of time, which is a point in time when an afterglow due to the relevant subfield is the largest. Precisely, this arrow should be denoted for each pulse that makes panel 107 emits light. Further, one end of another arrow at the bottom stage denotes a predetermined point in time of the frame subsequent to the relevant frame. The predetermined point in time will be described later. The middle stage in FIG. 3 shows an afterglow of each subfield of subfield signal 300. Afterglows 301 through 305 denote the amounts of the afterglows that occur from the subfields of subfield signal 300 respectively. In FIG. 3, the vertical axis at the middle stage shows the magnitude of the afterglows.

From FIG. 3, it may be understood that afterglows 301 to 305 increase as time passes by from the start of the respective subfields and, if they end light emission, decrease as time passes by. That is, with the vertical axis giving the magnitude of afterglows and the horizontal axis giving the time, afterglows 301 to 305 have substantially a triangular history of the afterglow amount.

If attention is focused on afterglows 301 to 305 individually, it may be understood that some of them have an afterglow amount even after the subsequent frame starts. Specifically, afterglow 301 is based on the subfield that makes the panel emit light first in the current frame and has a smaller number of times of light emission and, therefore, gives little afterglow to the subsequent frame.

On the other side, afterglow 305 is based on the subfield that makes the panel last in the current frame and has a larger number of times of light emission and, therefore, gives about a half of the maximum afterglow amount at the start of the subsequent frame. A sum of the afterglow amounts of afterglows 301 to 305 at a predetermined point in time in the subsequent frame gives a filtering-in amount. This predetermined point in time should preferably be a point in time when a video corresponding to the subsequent frame is displayed in this subsequent frame and the user would perceive it. A value corresponding to a sum of the afterglow amounts of afterglows 301 to 305 at the predetermined point in time in the subsequent frame gives the value of coefficient α. The value of coefficient α is not the sum itself of the afterglow amounts that occurred in the subfields but corresponds to the amount of an afterglow that occurred in the subfields and is determined from a sum of the afterglow amounts at the predetermined point in time. That is, if the sum of the afterglow amounts that occur in the subfields of the subfield signal is the same as that of the other subfield signal, they have the same value of α.

Although the value of coefficient α has been described schematically with reference to FIG. 3, the actual value of coefficient α is obtained from the drive parameter as described above. That is, the value of coefficient α is obtained on the basis of a luminance weight and a light emitting position. This is because the sum of afterglow amounts is obtained on the basis of the luminance weight and the light emitting position. The value of coefficient α can be expressed as a ratio at which an afterglow of the subfield signal in the current frame filters in the subfield signal in the subsequent frame. The value of coefficient α can be obtained from the drive parameter by measuring the drive parameter with changing it variously or by defining an increase rate of the afterglow amount for each pulse and an attenuation rate of the afterglow amount for each unit time, and applying them to the drive parameter. That is, assuming that the increase rate of the afterglow amount per pulse to be L, the weight at subfield i (i: a number in a total of n subfields) to be Gi, the attenuation rate at time t to be D(t), and the lapse of time (which may be the light emitting position itself or α value obtained by adding a predetermined value to or subtracting it from the light emitting position) that elapses from the end of the subfield to a predetermined point in time when the filtering-in amount is detected to be Ti, the following equation is obtained:

$$Value of α ∝ {\sum }_{i = 1}^{i = n} ( L \times Gi \times D ( Ti ) ) \qquad ( Equation 1 )$$

As described above, calculation unit 108 calculates filtering-in amounts of the frame signals corresponding to a plurality of the subfields based on the signal level of the frame signal, the setup luminance weight, and the light emitting position. Further, the calculation unit 108 calculates a greater amount of the setup luminance weight at the greater filtering-in amount of the frame signal. The value of coefficient α calculated by calculation unit 108 is transferred to combination unit 109.

Combination unit 109 obtains a filtering-in amount by computing the frame signal delayed in frame memory 102 and the value of coefficient α. One example will be described for obtaining the filtering-in amount by multiplying the frame signal and the value of coefficient α. The frame signal includes the values of signal levels of a plurality of picture elements. It is assumed that the green signal level of one of the picture elements is 100. If the value of coefficient α is assumed to be 0.1, the filtering-in amount becomes 10. By performing this computation on all of the picture elements, the frame signal is formed in which the signal levels of the picture elements are each multiplied by 0.1. This formed frame signal provides a filtering-in amount. The frame signal is delayed in frame memory 102 in order to calculate the filtering-in amount of the relevant frame signal by computing a sum of the afterglow amounts occurring due to this frame signal by feeding back the sum to this frame signal. The calculated filtering-in amount is transferred to addition unit 103.

As described above, addition unit 103 subtracts the filtering-in amount from the video signal to generate a second video signal. Therefore, the filtering-in amount of the previous frame signal is subtracted from that of the current frame signal. That is, addition unit 103 is substantially a subtraction unit and subtracts the filtering-in amount from a signal level of a frame signal input to the subfield conversion unit subsequent to the frame signal.

A description will be given to operations of the equipment by using the above-described video signal processing device with reference to an example of processing a three-dimensional video signal.

The three-dimensional video signal is a video signal having a right-eye video frame and a left-eye video frame. The right-eye video frame and the left-eye video frame are input to input unit 101 alternately. Panel 107 displays a right-eye video and a left-eye video alternately.

The user wears the shutter-attached glasses to appreciate the displayed video. The shutter-attached glasses include a shutter which blocks the right-eye viewfield and a shutter which blocks the left-eye viewfield. If the right-eye video is displayed, the left-eye shutter is closed so that this right-eye video may be seen on the right eye. If the left-eye video is displayed, the right-eye shutter is closed so that this left-eye video may be seen on the left eye.

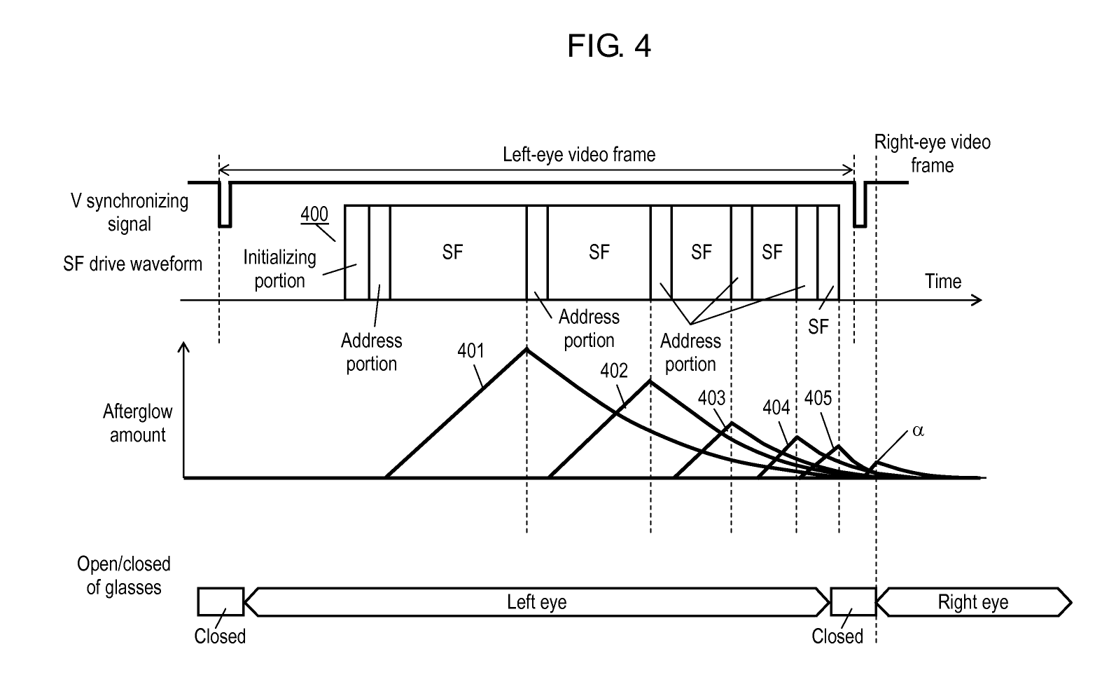

FIG. 4 shows a conceptual diagram of an operation state of the video signal processing device according to the exemplary embodiment. A description will be given of the operations of the video processing device in a case where the left-eye video frame is displayed after the right-eye video frame is input. For simplification of the description, it is assumed that the right-eye video frame prior to the left-eye video frame has no filtering-in amount. In FIG. 4, the top stage denotes a vertical synchronizing signal (V synchronizing signal). Below it, subfield signal 400 showing a subfield (SF) drive waveform is denoted. In FIG. 4, a horizontal axis gives time. The weights of subfield signal 400 are, for example, 128, 64, 32, 16, and 8 sequentially from the left. In this case, it is assumed that all of the subfields of subfield signal 400 make panel 107 emit light. The light emitting positions of subfield signal 400 are not denoted by arrows in particular and may be considered to be almost the same in FIG. 3.

In FIG. 4, the bottom stage shows an open/close timing chart of the glass shutters. In a zone denoted as “closed”, both of the right-eye shutter and the left-eye shutter are closed. In the zone denoted as “left-eye”, only the left-eye shutter is open. In the zone denoted as “right-eye”, only the right-eye shutter is open.

Comparison between the middle stage and the bottom stage in FIG. 4 shows that the left-eye shutter is open corresponding to subfield signal 400. This is because subfield signal 400 is in the left-eye video frame. FIG. 4 shows afterglows of the subfields of subfield signal 400. Afterglows 401 to 405 each denotes an amount of the afterglow of each of the subfields of subfield signal 400. The vertical axis of FIG. 4 gives the magnitude of the afterglow amount.

As described above, calculation unit 108 calculates the value of coefficient α based on the drive parameter set to subfield signal 400. This value of coefficient α should preferably be calculated at the timing when the right-eye shutter is opened in the right-eye video frame subsequent to the left-eye video frame. This is because the user perceives the right-eye video when the right-eye shutter is opened and, simultaneously, perceives the afterglows, that is, the filtering-in amounts of the subfields of subfield signal 400. As described above, the calculation unit 108 calculates a smaller amount of the filtering-in amount at a greater distance of the light emitting position from a shutter open timing in a frame period subsequent to the frame signal.

The thus calculated value of coefficient α is computed with the left-eye video signal accumulated in frame memory 102 to determine a filtering-in amount occurring due to subfield signal 400. The obtained filtering-in amount is subtracted from a signal level of the subsequent right-eye video signal. In such a manner, the filtering-in amount occurring due to subfield signal 400 in the left-eye video frame is subtracted from the subsequent right-eye video signal, thereby solving the problem of crosstalks.

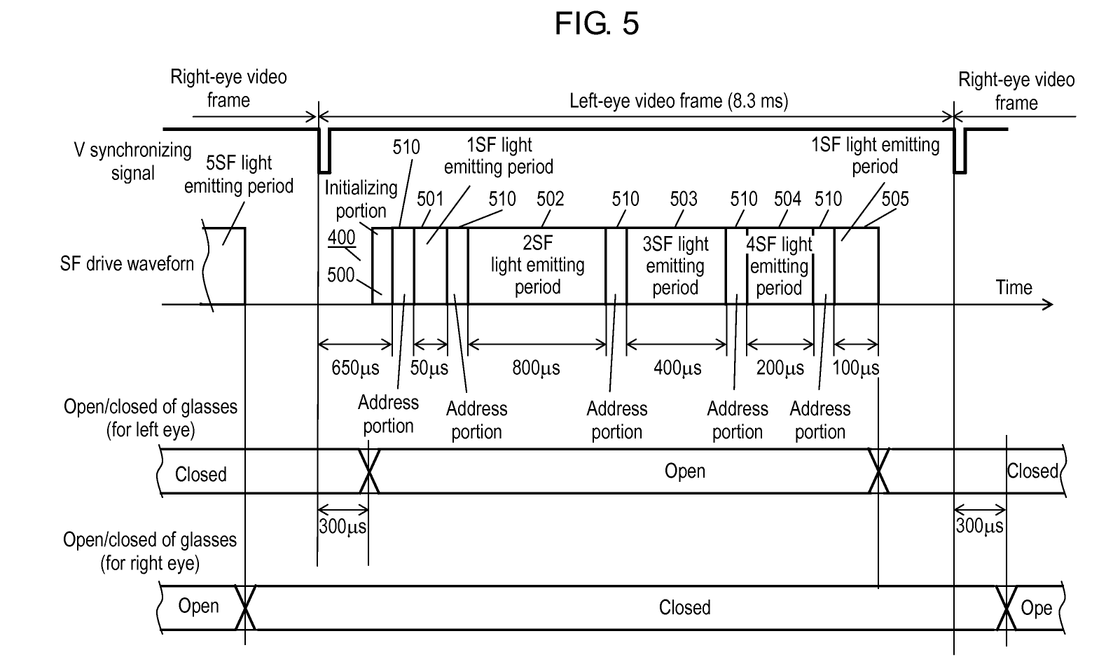

FIG. 5 shows a conceptual diagram of the operation state of the video signal processing device according to the exemplary embodiment. In FIG. 5, the top stage denotes a vertical synchronizing signal (V synchronizing signal). Below it, subfield signal 400 showing a subfield (SF) drive waveform is denoted. Moreover, timings are shown at which the left-eye shutter and the right-eye shutter for the glasses are opened/closed. In FIG. 5, a horizontal axis gives time. As shown from the timings, which are just one example, a time lapse of 650 μs elapses from the vertical synchronizing signal to the start of first address portion 510 included in a subfield. Further, address portion 510 has a period of 500 μs. For example, if the left-eye video frame is the current frame, a timing at which the left-eye shutter of the shutter-attached glasses is opened is 300 μs from the vertical synchronizing signal. Although not shown completely, the right-eye shutter might as well be operated similarly in the case of the right-eye video frame.

The shutter is opened at a timing that provides a starting point at which coefficient α corresponding to a sum of afterglows shown in FIGS. 3 and 4 is calculated. As described above, the starting point should preferably be set later as much as possible in the frame subsequent to the current one. However, the shutter needs to be opened completely before the start of the first subfield (1SF), which provides the first light emitting period in the frame.

That is, preferably drive parameter setting unit 105 should completely open the shutter on the glasses on the side corresponding to a video of the current frame before the end of first address portion 510 included in the subfield ends. In such a manner, the starting point at which coefficient α is calculated can be set later, thereby reducing the value of coefficient α. As a result, it is possible to suppress the occurrence of a crosstalk in the subsequent frame. Further, the timing at which the shutter corresponding to a video of the current frame of the shutter-attached glasses starts to be closed can be made a timing at which the fifth subfield (5SF) providing the last light emitting period in the frame completes.

As hereinabove described, the video signal processing device of the present exemplary embodiment calculates a sum of filtering-in amounts due to the subfields and subtracts it from a signal level of the subsequent frame and, therefore, can reduce the filtering-in amount accurately. As a result, it is possible to prevent a crosstalk from occurring between the video frames.

The video signal processing described with reference to the present exemplary embodiment solves the problems of crosstalks between the video frames and, therefore, is well suited in particular for applications involving the processing of a three-dimensional video signal including a left-eye video signal and a right-eye video signal. However, there is a case where dissipation power may possibly increase due to such video signal processing always. Therefore, a configuration to detect the type of the video signal may be added separately to decide whether the video signal is of a three-dimensional video and, if so, perform the video signal processing.

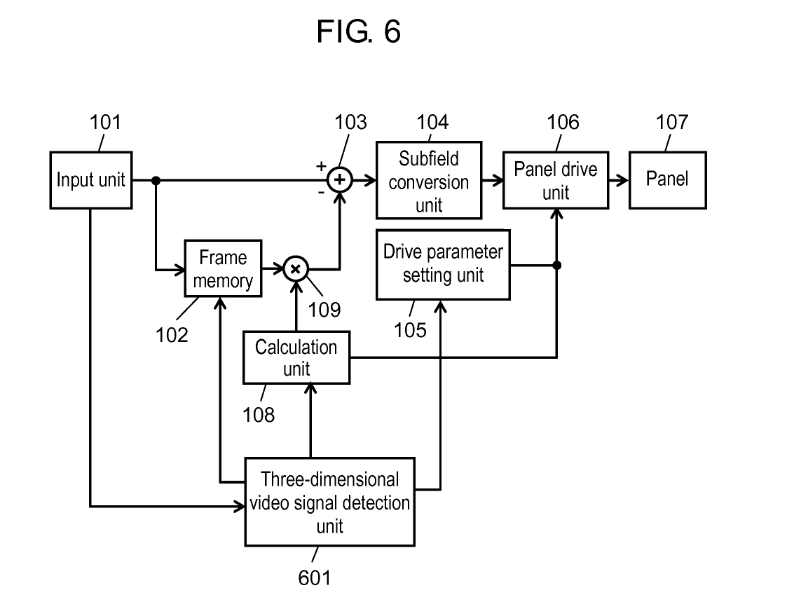

FIG. 6 shows a functional block diagram of the video signal processing device in another example according to the exemplary embodiment. As shown in FIG. 6, the video signal processing device in this example is different from that shown in FIG. 1 in that it further includes three-dimensional video signal decision unit 601. Three-dimensional video signal decision unit 601 sets the value of coefficient α to 0 when the video signal is not of a three-dimensional video. It eliminates the need of subtracting a filtering-in amount of the previous frame from a signal level of the current frame signal. Further, to prevent an increase in dissipation power, three-dimensional video signal decision unit 601 outputs a signal which stops the circuits necessary for the signal processing of the three-dimensional video signal, such as frame memory 102 and calculation unit 108. Although not shown, three-dimensional video signal decision unit 601 stops operations of the circuit for controlling the shutter-attached glasses and the circuit for transmitting the shutter-attached glasses control signal.

There is a case where a video may blur due to a crosstalk between the current frame and the subsequent frame also in the processing of an ordinary video signal not of a three-dimensional video, so that it is possible to apply the video signal processing described with reference to the present exemplary embodiment to the processing of the ordinary video signal.

Further, as shown in FIG. 4, the larger the luminance weight is, the larger the afterglow amount becomes. Further, the smaller calculation unit 108 calculates the filtering-in amount of the frame signal, the more distant the light emitting position is from the timing at which the shutter is opened in a frame period subsequent to the frame signal. Therefore, preferably drive parameter setting unit 105 should dispose the subfields in descending order of the set luminance weight, for forming one frame. By disposing the subfields in such a manner, it is possible to reduce coefficient α, which is a value corresponding to the sum of the afterglows, in FIG. 5 much less than the case of disposition in FIG. 4. As a result, the filtering-in amount to be subtracted from the video signal is reduced. Therefore, the filtering-in amount can be calculated more accurately, thereby reducing coefficient α further less.

Further, as described above, the larger the luminance weight is, the larger the afterglow amount becomes. Therefore, by disposing a subfield having a luminance weight equal to or greater than a predetermined value in the first half of one frame, coefficient α can be reduced sufficiently. In this case, the predetermined luminance weight value may be set to, for example, a half of the maximum luminance weight. Therefore, drive parameter setting unit 105 may dispose a subfield having equal to or greater than the predetermined luminance weight value in the first half of one frame and may dispose a subfield having the smaller luminance weight than the predetermined value in a latter half of the one frame. Furthermore, drive parameter setting unit 105 may dispose the subfield having equal to or greater than the predetermined luminance weight value in the first half of one frame and the subfields having the smaller luminance weight than the predetermined value in the latter half of the one frame in descending order of the luminance weight. By disposing the subfields in such a manner, coefficient α, which corresponds to the sum of the afterglows, can be reduced. As a result it is possible to prevent a crosstalk from occurring between the video frames.

What is claimed is:

1. A video signal processing device comprising:
a subfield conversion unit which converts a frame signal, which is a video signal corresponding to one frame of video, into a plurality of subfields corresponding to the frame signal;
a drive parameter setting unit which sets:
a luminance weight; and
a light emitting position in the plurality of subfields:
for each of the plurality of subfields;
a calculation unit which calculates a filtering-in amount of the frame signal corresponding to the plurality of subfields based on a signal level of the frame signal, the setup luminance weight, and the light emitting position; and
a subtraction unit which subtracts the filtering-in amount from a signal level of a frame signal input to the subfield conversion unit subsequent to the frame signal.

2. The video signal processing device according to claim 1, further comprising a three-dimensional signal decision unit, wherein
only when the video signal is a three-dimensional video signal, subtraction is performed by the subtraction unit.

3. The video signal processing device according to claim 1,
wherein the calculation unit calculates a smaller amount of the filtering-in amount at a greater distance of the light emitting position from a shutter open timing in a frame period subsequent to the frame signal.

4. The video signal processing device according to claim 1,
wherein the calculation unit calculates a greater amount of the setup luminance weight at the greater filtering-in amount of the frame signal.

5. The video signal processing device according to claim 1, wherein
the drive parameter setting unit completely opens the shutter of glasses on the side corresponding to a video of the current frame before a first address portion included in the subfield ends.

6. The video signal processing device according to claim 1, wherein
the drive parameter setting unit disposes the subfields in descending order of the set luminance weight, for forming the one frame.

7. The video signal processing device according to claim 1, wherein
the drive parameter setting unit:
disposes a subfield having the luminance weight equal to or greater than a predetermined value in a first half of the one frame; and
disposes a subfield having the luminance weight smaller than the predetermined value in a latter half of the one frame.

8. The video signal processing device according to claim 1, wherein
the drive parameter setting unit:
disposes a subfield having the luminance weight equal to or greater than a predetermined value in a first half of the one frame; and
disposes a subfield having the luminance weight smaller than the predetermined value in the latter half of the one frame in descending order of the luminance weight.
